(19) United States
(12) Patent Application Publication
(10) Pub. No.: US 2024/0010912 A1
(43) Pub. Date: Jan. 11, 2024

(54) REAGENT FOR DETECTING METHYL SALICYLATE, METHYL SLICYLATE SENSOR, METHOD FOR SENSING METHYL SALICYLATE USING SAME, AND METHOD FOR DETECTING PATHOGEN INFECTION IN PLANT

(71) Applicant: NEC Corporation, Tokyo (JP)

(72) Inventor: Katsumi Maeda, Tokyo (JP)

(73) Assignee: NEC Corporation, Tokyo (JP)

(21) Appl. No.: 18/216,288

(22) Filed: Jun. 29, 2023

(30) Foreign Application Priority Data
Jul. 5, 2022 (JP) 2022-108243

(51) Int. Cl. C09K 11/06; G01N 21/64

(52) U.S. Cl. CPC C09K 11/06; G01N 21/6428; G01N 2021/6439; C09K 2211/182

(57) ABSTRACT

The present invention provides a reagent for detecting methyl salicylate, which is a plant hormone released when a plant is infected with a disease, in the cultivation of plants including agricultural crops, a methyl salicylate sensor, and a method for sensing methyl salicylate using the same, thereby providing a method for early detection of pathogen infection in a plant.

A reagent for detecting methyl salicylate comprising a terbium compound and a non-volatile ionic liquid. A methyl salicylate sensor for detecting methyl salicylate comprising: a capture section of methyl salicylate having the reagent and a detection section detecting that methyl salicylate has been captured by the capture section.

This application is based upon and claims the benefit of priority from Japanese patent application No. 2022-108243, filed on Jul. 5, 2022, the disclosure of which is incorporated herein in its entirety by reference.

### TECHNICAL FIELD

The present invention relates to a reagent for detecting methyl salicylate, which is a plant hormone released when plants are infected with pathogens, a methyl salicylate sensor, a method for sensing methyl salicylate using the same, and a method for early detection of pathogen infection in a plant.

### BACKGROUND ART

It is known that when a plant is infected with a pathogen, it synthesizes and releases a plant hormone, which is a signal substance, and informs surrounding plants of the pathogen infection, thereby promoting a defense mechanism in advance. By quickly recognizing a signal substance emitted by such plant, it becomes possible to detect pest damage at an early stage.

As a method for early detection of pest damage to a target plant, for example, Patent document 1 describes a method in which a monitor plant having a photoprotein gene is placed in the vicinity of a target plant, and the monitor plant senses volatile substances released by the target plant in response to stress and emits light.

### CITATION LIST

### Patent Literature

Patent Document 1: WO2019/082942A1

### SUMMARY OF INVENTION

### Technical Problem

An object of the present invention is to provide a reagent for detecting methyl salicylate, which is a plant hormone released when a plant is infected with a disease, in the cultivation of plants including agricultural crops, a methyl salicylate sensor, and a method for sensing methyl salicylate using the same, thereby providing a method for early detection of pathogen infection in a plant.

### Solution to Problem

The present inventors have made intensive studies to solve the above problems. As a result, by containing a non-volatile ionic liquid together with a terbium compound which is a receptor for methyl salicylate, methyl salicylate can be captured more effectively, and as a result, the inventors have found that the fluorescence emission from the complex produced by the reaction between the terbium compound and methyl salicylate increases, and that the pathogen infection in a plant can be detected at an early stage, and the present invention has been completed.

One aspect of the present embodiment relates to a reagent for detecting methyl salicylate comprising a terbium compound and a non-volatile ionic liquid.

Further, one aspect of the present embodiment relates to a methyl salicylate sensor for detecting methyl salicylate comprising:
a capture section of methyl salicylate having the reagent according to any of the preceding Supplementary notes, and
a detection section detecting that methyl salicylate has been captured by the capture section.

### Advantageous Effect of Invention

According to the present invention, by including a non-volatile ionic liquid together with a terbium compound which is a receptor for methyl salicylate in a reagent for detecting methyl salicylate, methyl salicylate, which is a volatile plant hormone released when plants are infected with pathogens, can be effectively captured, and as a result, more of the captured methyl salicylate reacts with the terbium compound, and the intensity of fluorescence emission from the complex thus formed increases, making it possible to detect infection of plants by pathogens at an early stage.

### BRIEF DESCRIPTION OF DRAWINGS

FIG. 1 is a photograph confirming fluorescence emission in Example 1.

FIG. 2 shows fluorescence spectrum curves obtained by measurement in Example 1 and Comparative example 1.

FIG. 3 is a photograph confirming fluorescence emission in Example 2.

FIG. 4 shows fluorescence spectrum curves obtained by measurement in Example 4 as well as Example 1 and Comparative example 1.

FIG. 5 is a photograph confirming fluorescence emission in Example 5.

FIG. 6 shows fluorescence spectrum curves obtained by measurement in Example 5 and Comparative example 2.

### DESCRIPTION OF EMBODIMENTS

The modes for carrying out the invention will be described below with reference to drawings and the like. However, the embodiments described below are technically preferable for carrying out the present invention, but the scope of the invention is not limited to the following.

### [1] Reagent for Detecting Methyl Salicylate

One embodiment of the present invention is a reagent for detecting methyl salicylate, comprising a terbium compound which is a receptor that selectively recognizes methyl salicylate and a non-volatile ionic liquid that effectively captures methyl salicylate. In the reagent, the terbium compound exists dissolved in the non-volatile ionic liquid, but part of it may be precipitated. A terbium compound can similarly function as a receptor for methyl salicylate whether dissolved in a non-volatile ionic liquid or precipitated.

In the present invention, the term “reagent” is defined as a chemical substance used for the detection or quantification of substances by chemical methods, the experiments of the synthesis of substances or the measurement of physical properties.

### (Receptor of Methyl Salicylate: Terbium Compound)

The terbium compound that can be used to recognize methyl salicylate in the present invention is preferably a terbium carboxylate, and specifically includes, but is not limited to, terbium acetate, terbium pivalate, terbium propionate, terbium isobutyrate, terbium cyclopentane carboxylate, terbium benzoate, and terbium nonanoate.

The terbium compound includes complexes of terbium carboxylates and phosphine oxide derivatives, and examples thereof include those shown in Table 1, but are not limited thereto.

TABLE 1

| | Structural formula |
|---|---|
| TbPv-NBPO | 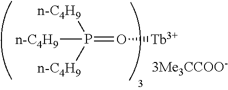 |
| TbPv-CH3PO | 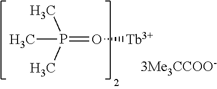 |
| TbA-MTPO | 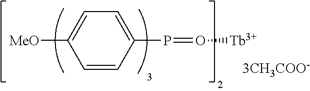 |
| TbA-NOPO | 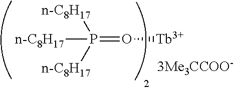 |
| TbA-TTPO | 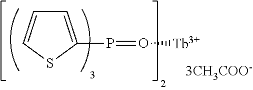 |
| TbA-BDPO | 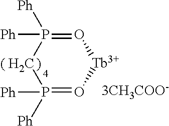 |

Furthermore, terbium compounds include complexes of terbium carboxylates and sulfoxide derivatives shown in Table 2, and examples thereof include, but are not limited to, those shown in Table 2.

TABLE 2

| | Structural formula |
|---|---|
| Tb-S1 | 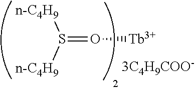 |
| Tb-S2 | 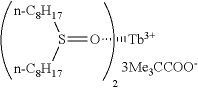 |
| Tb-S3 | 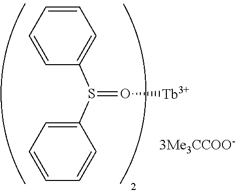 |
| Tb-S4 | 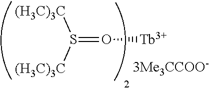 |
| Tb-S5 | 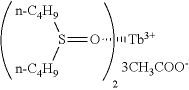 |
| Tb-S6 | 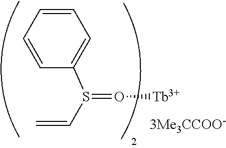 |

A terbium compound such as terbium pivalate (TbPv) can be synthesized by reacting terbium chloride hexahydrate and sodium pivalate in water, as shown in the following Formula (1).

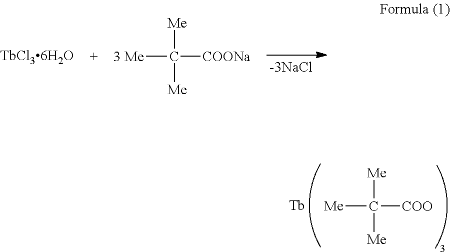

Then, the terbium compound can selectively recognize methyl salicylate by reacting with methyl salicylate to form a methyl salicylate complex. For example, terbium pivalate forms a complex with methyl salicylate by the reaction represented by the following Formula (2).

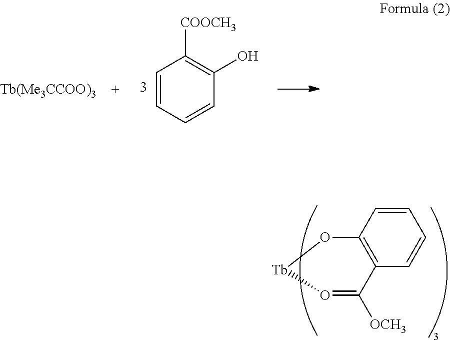

The resulting methyl salicylate complex emits fluorescence peculiar to terbium complexes when excited with UV. When the terbium compound alone is irradiated with UV light, no fluorescence emission is observed. In addition, the terbium compound does not react with and does not recognize plant hormones other than methyl salicylate, such as methyl jasmonate, so they can selectively recognize methyl salicylate.

### (Non-Volatile Ionic Liquid)

Examples of non-volatile ionic liquids that can be used in the present invention include imidazolium salts, phosphonium salts, pyridinium salts, ammonium salts, piperidinium salts, and pyrrolidinium salts. Specific examples include 1-ethyl-3-methylimidazolium acetate, 1-butyl-3-methylimidazolium acetate, 1-ethyl-3-methylimidazolium tetrafluoroborate, 1-butyl-1-methylpyrrolidinium bis(fluorosulfonyl)imide, 1-butyl-3-methylimidazolium dibutyl phosphate, tetrabutylammonium acetate, 1-butylpyridinium bis(trifluoromethanesulfonyl)imide, 1-methyl-1-propylpiperidinium bis(fluorosulfonyl)imide, 1-ethyl-3-methylimidazolium bis(trifluoromethanesulfonyl)imide, and 1-butyl-3-methylimidazolium dicyanamide, but are not limited to these.

The weight ratio of the ionic liquid to the terbium compound is preferably 2 to 40 times, more preferably 3 to 30 times, particularly preferably 4 to 20 times. If the weight ratio of the ionic liquid to the terbium compound is less than 2 times, the effect of improving the methyl salicylate detection sensitivity may not be obtained. If the weight ratio of the ionic liquid to the terbium compound exceeds 40 times, it may become difficult for the terbium compound to form a complex with methyl salicylate.

The reagent for detecting methyl salicylate of the present invention may optionally comprise other solvents if the effects of the present invention are not impaired. Examples of solvents that can be used include, but are not limited to, dimethyl sulfoxide, methanol, ethanol, water, N,N-dimethylformamide, tetrahydrofuran, acetone, acetonitrile, and 1,4-dioxane.

### [2] Methyl Salicylate Sensor

One embodiment of the present invention relates to a methyl salicylate sensor for detecting methyl salicylate comprising: a capture section of methyl salicylate having the reagent and a detection section for detecting that methyl salicylate has been captured by the capture section.

### (1) Capture Section

The capture section of methyl salicylate sensor of the present invention has a reagent comprising a terbium compound, which is a receptor that selectively recognizes methyl salicylate, and a non-volatile ionic liquid that effectively captures methyl salicylate. In the capture section, the reagent is preferably contained in the medium.

### (Medium)

The medium containing the terbium compound and the ionic liquid of the present invention may be, includes, but is not limited to, for example, a paper or a glass fiber, a resin (for example, polymethyl methacrylate, polyethylene, polypropylene, polyvinyl chloride, polystyrene, nylon resin, polyamide, polycarbonate, polyethylene terephthalate, polybutylene terephthalate, polyphenylene oxide), a water-soluble polymer (such as cellulose, agarose, starch, sodium alginate, acrylic acid, acrylamide, polyvinyl alcohol, polyethylene oxide, polyvinylpyrrolidone).

For example, when paper is used as a medium, a terbium compound is dissolved in a solvent, an ionic liquid is added thereto, paper (for example, filter paper) is impregnated with the resulting solution, and the solvent is removed by drying at room temperature to 60° C. to obtain a medium containing the terbium compound and the non-volatile ionic liquid. The medium can be impregnated with a mixture of a terbium compound and a non-volatile ionic liquid without using a solvent. However, the use of a solvent is preferable because it facilitates impregnation of the medium with the terbium compound and facilitates adjustment of the concentration of the terbium compound. After removing the solvent, the terbium compound is dissolved in the non-volatile ionic liquid, but part of it may be precipitated. A terbium compound can similarly function as a receptor for methyl salicylate whether dissolved in a non-volatile ionic liquid or precipitated.

As a solvent for dissolving the terbium compound, dimethyl sulfoxide, methanol, ethanol, water, N,N-dimethylformamide, tetrahydrofuran, acetone, acetonitrile, and 1,4-dioxane can be used, but are limited to these.

Also, the ratio of the ionic liquid to the solvent can be appropriately decided depending on the medium to be impregnated. When the ratio of the ionic liquid to the solvent is low, the amount of the ionic liquid in the medium after drying is small, and the effect of improving the detection sensitivity may be small. On the other hand, when the ratio of the ionic liquid to the solvent is high, the ionic liquid has a high viscosity, which may disadvantageously make it difficult to impregnate the medium. Therefore, the ratio of the ionic liquid to the solvent is appropriately decided depending on the medium. For example, when filter paper is impregnated, the ratio of the ionic liquid to the solvent is preferably 5 to 50% by weight, more preferably 10 to 30% by weight.

### (2) Detection Section

The detection section of the methyl salicylate sensor of the present invention is configured to optically detect that methyl salicylate has been captured by the capture section. The detection section may be configured as a separate device instead of being integrated with the capture section. In one aspect of the present invention, the optical detection section has an excitation light source (light-emitting part) and a detecting element (fluorescence-receiving part) in order to detect the fluorescence emission of a complex (methyl salicylate complex) formed by a terbium compound and methyl salicylate, detection and/or concentration measurement of methyl salicylate can be performed based on the change in fluorescence intensity observed.

In one aspect of the present invention, the detection section may include a computer executing a program to process the detection and/or concentration measurement of methyl salicylate. Such a program may be, for example, a program that causes a computer to (i) receive a signal from an optical detecting element, (ii) determine the presence or absence and/or the concentration of methyl salicylate by analyzing the received signal, and (iii) output the analysis results.

In one aspect of the present invention, analysis of the received signal may include determining the presence or absence and/or the concentration of methyl salicylate, for example by comparing the received signal to a predetermined reference value. Also, in one aspect of the present invention, analysis results can be output to, for example, a display device connected to the sensor, or other equipment connected via a network.

In one aspect of the present invention, the methyl salicylate sensor of the present invention senses methyl salicylate, which is a plant hormone released when agricultural crops are infected with pathogens. Therefore, the methyl salicylate sensor of the present invention can be used as a sensor for detecting pathogen infection in plants including agricultural crops.

### [3] Method for Sensing Methyl Salicylate

One aspect of the invention relates to a method for sensing methyl salicylate using fluorescence emission from a complex obtained by reacting a terbium compound with methyl salicylate using the reagent or methyl salicylate sensor, wherein the method comprises:
(i) forming a complex by reacting a terbium compound with methyl salicylate;
(ii) exposing the complex to excitation light;
(iii) detecting fluorescence emitted by the complex.

While the terbium compound alone hardly exhibits fluorescence emission, the complex produced by the reaction of the terbium compound and methyl salicylate newly exhibits fluorescence emission. Thus, methyl salicylate can be detected by utilizing this phenomenon.

In one aspect of the invention, a suitable wavelength in the range of 300 to 400 nm is selected as the excitation wavelength. Further, in one aspect of the invention, the determination of the concentration of methyl salicylate can also be performed by comparing the intensity of the detected fluorescence with a predetermined reference value.

### [4] Method for Detecting Pathogen Infection in a Plant

One aspect of the invention relates to a method for detecting pathogen infection in plants by placing the reagent or methyl salicylate sensor near the plant and confirming fluorescence emission derived from the complex formed by the reaction between the terbium compound and methyl salicylate.

Examples of the plant that may be the monitoring target include, but are not limited to, cucumber, watermelon, tomato, eggplant, green pepper, paprika, green pepper, melon, Chinese cabbage, cabbage, radish, lettuce, green onion, broccoli, onion, garlic, yam, asparagus, carrot, potato, celery, tobacco, rice, and strawberry.

Examples of the disease that may be detected include, but are not limited to, ring spot disease, leaf spot, Corynespora target spot, leaf mold, Fusarium wilt, root rot wilt, Verticillium wilt, brown root rot, gray phytophthora rot, root rot, black dot root rot, southern blight, damping off, brown leaf spot, downy mildew, powdery mildew, gray mold, anthracnose, scab, Sclerotinia rot, gummy stem blight, leaf spot, blight, mosaic disease, spotted wilt, yellow leaf curl, bacterial wilt, bacterial soft rot, bacterial canker, pith necrosis, bacterial black spot, and bacterial leaf spot, and examples of the pathogen infection that may be detected include, but are not limited to, infections caused by the causative microorganisms of the above diseases.

In the context of the present disclosure, when referring to installing in the vicinity of a plant, examples of the term “vicinity” include, but are not limited to, a distance within 2 m, within 1 m, within 75 cm, within 50 cm, within 40 cm, within 30 cm, within 20 cm, within 10 cm, or within 5 cm of the plant to be monitored, and an appropriate distance is selected as appropriate in consideration of a variety of factors. A person skilled in the art would be able to set the position of the sensor to be installed as appropriate in consideration of a variety of conditions.

One embodiment of the present invention relates to the use of a reagent or a methyl salicylate sensor in detection of pathogen infection in a plant. One embodiment of the present invention relates to use of a terbium compound and an ionic liquid in production of a methyl salicylate sensor.

### EXAMPLES

Hereinafter, an embodiment of the present invention will be explained in details by using Examples, but the present invention is not limited to these Examples.

### Example 1

0.0462 g of terbium pivalate (TbPv) was dissolved in 1.8 ml of dimethyl sulfoxide (DMSO), 0.2 ml of 1-ethyl-3-methylimidazolium acetate (EMImAc) was added thereto (DMSO/EMImAc=9/1), and 0.2 ml of the solution was dropped onto a circular filter paper (D40 mm) and dried to volatilize DMSO to obtain a filter paper containing TbPv and EMImAc.

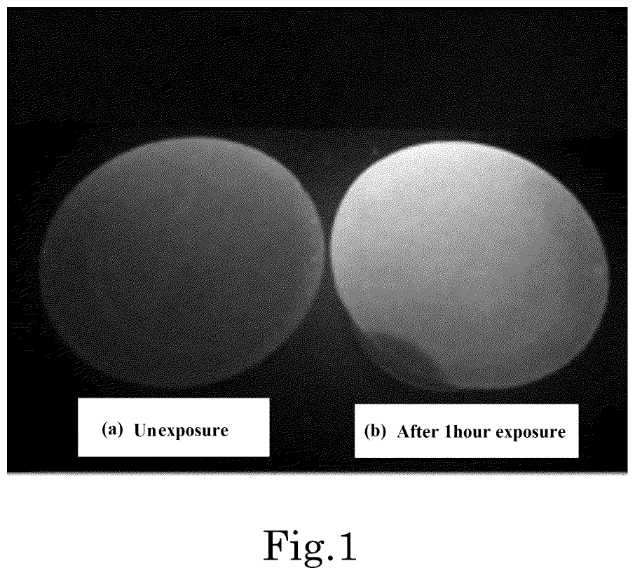

The resulting filter paper was excited with a UV lamp (wavelength: 365 nm) to confirm fluorescence emission (FIG. 1(a)). Further, the obtained filter paper was placed in a desiccator with a capacity of 800 ml, and methyl salicylate with a concentration of 40 ppb was introduced therein using nitrogen as a carrier gas. After 1 hour, the filter paper was taken out and similarly excited with a UV lamp to check for fluorescence emission (FIG. 1(b)).

As shown in FIG. 1, no yellow-green fluorescence emission characteristic of the Tb complex was observed in the unexposed sample (a), whereas yellow-green fluorescence emission was confirmed in the 1 hour-exposed sample (b). This result shows that the sensor containing TbPv and EMImAc can sense methyl salicylate at a concentration of 40 ppb.

### Comparative Example 1

0.0462 g of terbium pivalate (TbPv) was dissolved in 2 ml of dimethyl sulfoxide (DMSO), and 0.2 ml of the solution was dropped onto a circular filter paper (440 mm) and dried to volatilize DMSO to obtain a filter paper containing TbPv. The obtained filter paper was placed in a desiccator with a capacity of 800 ml, and methyl salicylate with a concentration of 40 ppb was introduced therein using nitrogen as a carrier gas. After 1 hour, the filter paper was taken out.

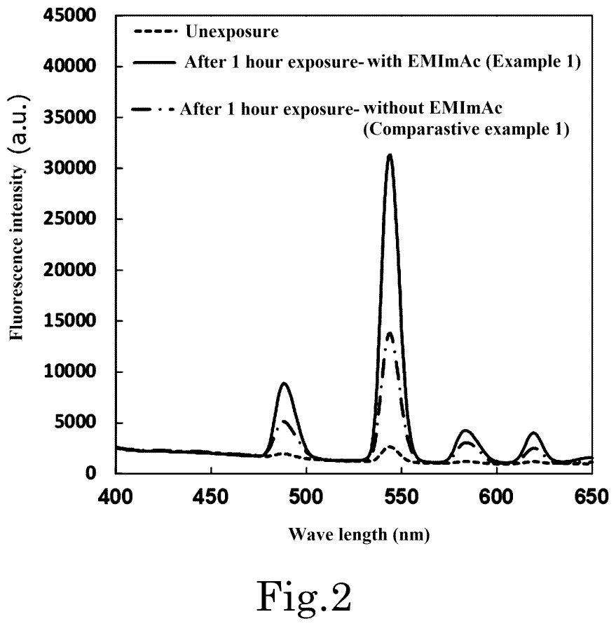

FIG. 2 shows fluorescence spectrum curves at an excitation wavelength of 365 nm after exposure for 1 hour and no exposure in Example 1, and a fluorescence spectrum curve at an excitation wavelength of 365 nm after exposure for 1 hour in Comparative example 1. The dashed line is the unexposed fluorescence spectrum in Example 1, the solid line is the fluorescence spectrum after exposure in Example 1, and the dashed-dotted line is the fluorescence spectrum after exposure in Comparative example 1.

From the results of Example 1 and Comparative example 1, the fluorescence emission intensity at a wavelength of 544 nm after exposure for 1 hour increased by about 2.3 times in the case of containing EMImAc, compared with the case of not containing EMImAc. It was found that the inclusion of EMImAc, which is a non-volatile ionic liquid, improves the sensing sensitivity of methyl salicylate.

### Example 2

0.0462 g of terbium pivalate (TbPv) was dissolved in 1.8 ml of dimethyl sulfoxide (DMSO), 0.2 ml of 1-butyl-3-methylimidazolium acetate (BMImAc) was added thereto (DMSO/BMImAc=9/1), and 0.2 ml of the solution was dropped onto a circular filter paper (440 mm) and dried to volatilize DMSO to obtain a filter paper containing TbPv and BMImAc.

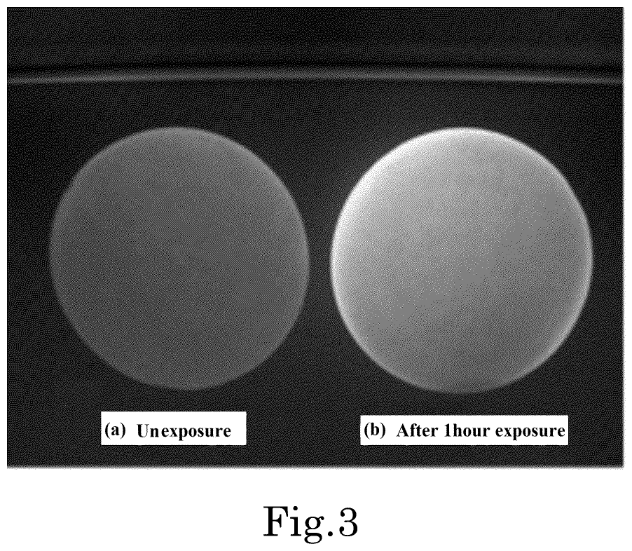

The resulting filter paper was excited with a UV lamp (wavelength: 365 nm) to confirm fluorescence emission (FIG. 3(a)). Further, the obtained filter paper was placed in a desiccator with a capacity of 800 ml, and methyl salicylate with a concentration of 40 ppb was introduced therein using nitrogen as a carrier gas. After 1 hour, the filter paper was taken out and similarly excited with a UV lamp to check for fluorescence emission (FIG. 3(b)).

As shown in FIG. 3, no yellow-green fluorescence emission characteristic of the Tb complex was observed in the unexposed sample (a), whereas yellow-green fluorescence emission was confirmed in the 1 hour-exposed sample (b). This result shows that the sensor containing TbPv and BMImAc can sense methyl salicylate at a concentration of 40 ppb.

### Example 3

0.0462 g of terbium pivalate (TbPv) was dissolved in 1.8 ml of dimethyl sulfoxide (DMSO), and 0.2 ml of 1-butyl-1-methylpyrrolidinium bis(fluorosulfonyl)imide (BMPyFSI) was added thereto (DMSO/BMPyFSI=9/1), and 0.2 ml of the solution was dropped onto a circular filter paper (D40 mm) and dried to volatilize DMSO to obtain a filter paper containing TbPv and BMPyFSI.

As in Example 1, the filter paper containing TbPv and BMPyFSI was examined for fluorescence after unexposed and 1 hour exposure to methyl salicylate. No yellow-green fluorescence emission characteristic of the Tb complex was observed in the unexposed sample, whereas yellow-green fluorescence emission was confirmed in the 1 hour-exposed sample. This result indicates that the sensor containing TbPv and BMPyFSI can sense methyl salicylate at a concentration of 40 ppb.

Table 3 summarizes the emission intensity values at a wavelength of 544 nm in the fluorescence spectra at an excitation wavelength of 365 nm after exposure for 1 hour in Examples 1 to 3 and Comparative example 1.

TABLE 3

| | | Sensitivity |
|---|---|---|
| | | (Ratio of |
| | | fluorescence |
| | | intensity at |
| | | wavelength |
| | Ionic liquind | 544 nm) |
| Example 1 | 1-ethyl-3-methylimidazolium acetate | 2.3 |
| Example 2 | 1-butyl-3-methylimidazolium acetate | 2 |
| Example 3 | 1-butyl-1-methylpyrrolidinium | 1.7 |
| | bis(fluorosulfonyl)imide | |
| Comparative | None | 1 |
| example 1 | | |

Compared to the case of not containing 1-ethyl-3-methylimidazolium acetate (EMImAc), the fluorescence emission intensity at a wavelength of 544 nm after 1 hour exposure increased by 2.3 times when containing EMImAc (Example 1). Compared to the case of not containing 1-butyl-3-methylimidazolium acetate (BMJmAc), the fluorescence emission intensity at a wavelength of 544 nm after 1-hour exposure increased by 2 times when containing BMJmAc (Example 2). Compared to the case of not containing 1-butyl sumethylpyrrolidinium bis(fluorosulfonyl)imide (BMPyFSI), the fluorescence emission intensity at a wavelength of 544 nm after 1 hour exposure when containing BMPyFSJ increased by 1.7 times when containing BMPyFSJ (Example 3). Thus, it was found that the sensing sensitivity of methyl salicylate was improved by containing a non-volatile ionic liquid.

### Example 4

0.0462 g of terbium pivalate (TbPv) was dissolved in 1.6 ml of dimethyl sulfoxide (DMSO), and 0.4 ml of 1-ethyl-3-methylimidazolium acetate (EMImAc) was added thereto (DMSO/EMJmAcf8/2), and 0.2 ml of the solution was dropped onto a circular filter paper (Φ40 mm) and dried to volatilize DMSO to obtain a filter paper containing TbPv and EMImAc.

The resulting filter paper was excited with a UV lamp (wavelength 365 nm) to measure the fluorescence spectrum. Further, the resulting filter paper was placed in a desiccator with a capacity of 800 ml, and methyl salicylate with a concentration of 40 ppb was introduced therein using nitrogen as a carrier gas. After 1 hour, the filter paper was taken out and similarly excited with a UV lamp to measure the fluorescence spectrum.

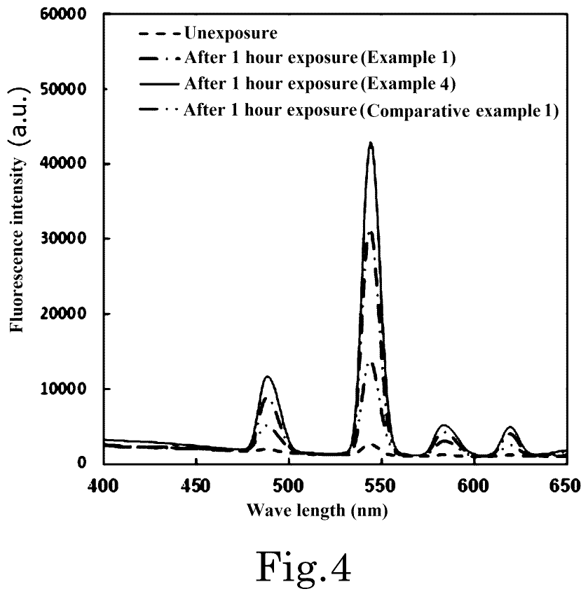

FIG. 4 shows the fluorescence spectrum curves at an excitation wavelength of 365 nm for non-exposure and 1-hour exposure in Example 4, and the fluorescence spectrum curves in Example 1 and Comparative example 1. The solid line is the fluorescence spectrum after exposure of Example 4, and the dashed line is the unexposed fluorescence spectrum of Example 4. The dashed-dotted line is the fluorescence spectrum of Example 1, and the dashed-two dotted line is the fluorescence spectrum of Comparative example 1. From a comparison of Example 1 and Example 4, it was found that Example 4, which has a large amount of EMImAc, which is a non-volatile ionic liquid, has a higher fluorescence emission intensity at 544 nm and is superior in detection sensitivity.

### Example 5

0.0408 g of terbium acetate (TbA) was dissolved in 1.8 ml of dimethylsulfoxide (DMSO), and 0.2 ml of 1-ethyl-3-methylimidazolium acetate (EMImAc) was added thereto (DMSO/EMImAc=9/1), and 0.2 ml of the solution was dropped on a circular filter paper (040 mm) and dried to volatilize DMSO to obtain a filter paper containing TbA and EMImAc.

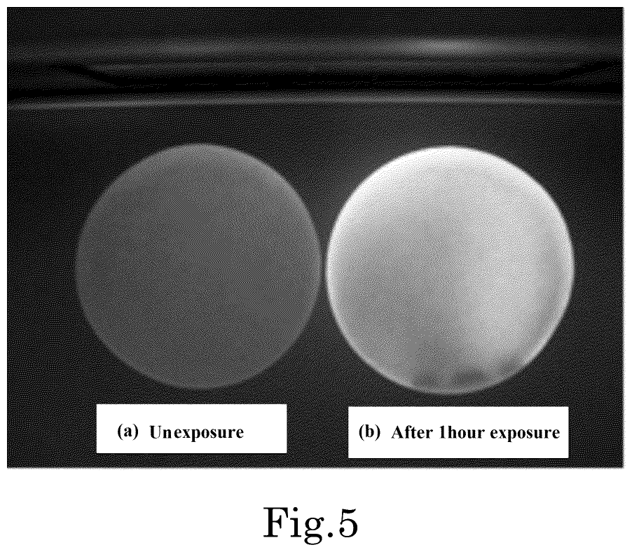

The resulting filter paper was excited with a UV lamp (wavelength: 365 nm) to confirm fluorescence emission (FIG. 5(a)). Further, the resulting filter paper was placed in a desiccator with a capacity of 800 ml, and methyl salicylate with a concentration of 40 ppb was introduced therein using nitrogen as a carrier gas. After 1 hour, the filter paper was taken out and similarly excited with a UV lamp to confirm the presence of fluorescence emission (FIG. 5(b)).

As shown in FIG. 5, no yellow-green fluorescence emission characteristic of the Tb complex was observed in the unexposed sample (a), whereas yellow-green fluorescence emission was confirmed in the 1 hour-exposed sample (b). This result shows that the sensor containing TbA and EMImAc can sense methyl salicylate at a concentration of 40 ppb.

### Comparative Example 2

0.0408 g of terbium acetate (TbA) was dissolved in 2 ml of dimethyl sulfoxide, and 0.2 ml of the solution was dropped onto a round filter paper (440 mm) and dried to volatilize DMSO to obtain a filter paper containing TbA. The resulting filter paper was placed in a desiccator with a capacity of 800 ml, and methyl salicylate with a concentration of 40 ppb was introduced therein using nitrogen as a carrier gas, and the filter paper was taken out after 1 hour.

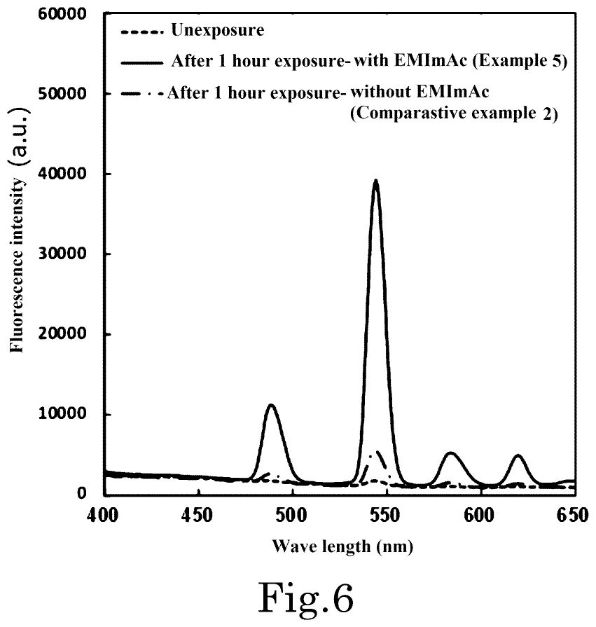

FIG. 6 shows fluorescence spectrum curves at an excitation wavelength of 365 nm after exposure for 1 hour and no exposure in Example 5, and fluorescence spectrum curve at an excitation wavelength of 365 nm after exposure for 1 hour in Comparative example 2. The dashed line is the unexposed fluorescence spectrum in Example 5, the solid line is the fluorescence spectrum after exposure in Example 5, and the dashed-dotted line is the fluorescence spectrum after exposure in Comparative example 2.

From the results of Example 5 and Comparative Example 2, the fluorescence emission intensity at a wavelength of 544 nm after exposure for 1 hour increased by about 7 times in the case of containing EMImAc, compared with the case of not containing EMImAc. It was found that the inclusion of EMImAc, which is a non-volatile ionic liquid, improves the sensing sensitivity of methyl salicylate.

### INDUSTRIAL APPLICABILITY

The methyl salicylate sensor for detecting methyl salicylate, which is a plant hormone of the present invention, can selectively detect methyl salicylate, which is a plant hormone released by plants during pathogen infection, because it efficiently captures methyl salicylate, forms a complex, and emits fluorescence by having a capture section having a medium containing a terbium compound and a non-volatile ionic liquid. In addition, pathogen infection in a plant can be detected at an early stage by using the methyl salicylate sensor. Specifically, the methyl salicylate sensor can be used as a new sensor for agricultural ICT in facility horticulture such as greenhouses, which can detect pathogen infection of agricultural crops at an early stage.

Although the present invention has been described with reference to the embodiments and Examples, the present invention is not limited to the above embodiments and Examples. Various modifications can be made to the configuration and details of the present invention within the scope of the present invention that can be understood by those skilled in the art.

### (Supplementary Note 1)

A reagent for detecting methyl salicylate comprising a terbium compound and a non-volatile ionic liquid.

### (Supplementary Note 2)

The reagent according to Supplementary note 1, wherein the ionic liquid is at least one selected from the group consisting of imidazolium salts, phosphonium salts, pyridinium salts, ammonium salts, piperidinium salts, and pyrrolidinium salts.

### (Supplementary Note 3)

The reagent according to Supplementary note 1 or 2, wherein the ionic liquid is at least one selected from the group consisting of 1-ethyl-3-methylimidazolium acetate, 1-butyl-3-methylimidazolium acetate, 1-ethyl-3-methylimidazolium tetrafluoroborate, 1-butyl-1-methylpyrrolidinium bis(fluorosulfonyl)imide, 1-butylpyridinium bis(trifluoromethanesulfonyl)imide, 1-methyl-1-propylpiperidinium bis(fluorosulfonyl)imide, 1-ethyl-3-methylimidazolium bis(trifluoromethanesulfonyl)imide, and methyl 1-butyl-3-methylimidazolium dicyanamate.

### (Supplementary Note 4)

The reagent according to any of the preceding Supplementary notes, wherein the terbium compound is terbium carboxylate.

### (Supplementary Note 5)

The reagent according to any of the preceding Supplementary notes, wherein the terbium compound is a terbium carboxylate complexed with a phosphine oxide derivative or a sulfoxide derivative.

### (Supplementary Note 6)

The reagent according to any of the preceding Supplementary notes, wherein the terbium carboxylate is at least one selected from the group consisting of terbium acetate, terbium pivalate, terbium propionate, terbium isobutyrate, terbium cyclopentanecarboxylate, terbium benzoate, and terbium nonanoate.

### (Supplementary Note 7)

The reagent according to any of the preceding Supplementary notes, wherein the weight ratio of the ionic liquid to the terbium compound is 2 to 40 times.

### (Supplementary Note 8)

A methyl salicylate sensor for detecting methyl salicylate comprising:
a capture section of methyl salicylate having the reagent according to any of the preceding Supplementary notes, and
a detection section detecting that methyl salicylate has been captured by the capture section.

### (Supplementary Note 9)

The methyl salicylate sensor according to Supplementary note 8, wherein the capture section comprises a medium containing the reagent.

### (Supplementary Note 10)

The methyl salicylate sensor according to Supplementary note 9, wherein the medium is a paper, a glass fiber, a resin, or a water-soluble polymer.

### (Supplementary Note 11)

The methyl salicylate sensor according to Supplementary note 10, wherein the detection section has an optical detecting element and a computer, and has a program that causes the computer to:
i) receive a signal from an optical detecting element;
ii) determine the presence or absence and/or the concentration of methyl salicylate by analyzing the received signal; and
iii) output the analysis results.

### (Supplementary Note 12)

A method for producing the methyl salicylate sensor according to Supplementary note 10 or 11, wherein comprising
dissolving the terbium compound in a solvent, adding an ionic liquid to the solution, impregnating the obtained solution into a medium, and drying the medium by removing the solvent, thereby obtaining a capture section of methyl salicylate having a medium containing the terbium compound and the ionic liquid.

### (Supplementary Note 13)

The method according to Supplementary note 12, wherein the ratio of the ionic liquid to the solvent is 5 to 50% by weight.

### (Supplementary Note 14)

A method for sensing methyl salicylate by recognizing methyl salicylate by using the reagent or the methyl salicylate sensor according to any of the preceding Supplementary notes, comprising:
(i) reacting a terbium compound with methyl salicylate to form a complex;
(ii) exposing the complex to excitation light;
(iii) detecting fluorescence emitted by the complex.

### (Supplementary Note 15)

A method for detecting pathogen infection in a plant by placing the reagent or the methyl salicylate sensor according to any of the preceding Supplementary notes in the vicinity of a plant and confirming fluorescence emission derived from a complex formed by reaction between a terbium compound and methyl salicylate.

### (Supplementary Note 16)

The method according to Supplementary note 15, using a wavelength within the range of 300 to 400 nm as the excitation wavelength of the excitation light.

### (Supplementary Note 17)

The method according to Supplementary note 15 or 16, wherein further comprising the determination of the concentration of methyl salicylate by comparing the intensity of the detected fluorescence to a predetermined reference value.

1. A reagent for detecting methyl salicylate comprising a terbium compound and a non-volatile ionic liquid.

2. The reagent according to claim 1, wherein the ionic liquid is at least one selected from the group consisting of imidazolium salts, phosphonium salts, pyridinium salts, ammonium salts, piperidinium salts, and pyrrolidinium salts.

3. The reagent according to claim 1, wherein the ionic liquid is at least one selected from the group consisting of 1-ethyl-3-methylimidazolium acetate, 1-butyl-3-methylimidazolium acetate, 1-ethyl-3-methylimidazolium tetrafluoroborate, 1-butyl-1-methylpyrrolidinium bis(fluorosulfonyl)imide, 1-butylpyridinium bis(trifluoromethanesulfonyl)imide, 1-methyl-1-propylpiperidinium bis(fluorosulfonyl)imide, 1-ethyl-3-methylimidazolium bis(trifluoromethanesulfonyl)imide, and methyl 1-butyl-3-methylimidazolium dicyanamate.

4. The reagent according to claim 1, wherein the terbium compound is terbium carboxylate.

5. The reagent according to claim 1, wherein the weight ratio of the ionic liquid to the terbium compound is 2 to 40 times.

6. A methyl salicylate sensor for detecting methyl salicylate comprising:
a capture section of methyl salicylate having the reagent according to claim 1, and
a detection section detecting that methyl salicylate has been captured by the capture section.

7. The methyl salicylate sensor according to claim 6, wherein the capture section comprises a medium containing the reagent.

8. The methyl salicylate sensor according to claim 7, wherein the medium is a paper, a glass fiber, a resin, or a water-soluble polymer.

9. A method for sensing methyl salicylate, comprising recognizing methyl salicylate using the reagent according to claim 1, comprising:
(i) reacting a terbium compound with methyl salicylate to form a complex;
(ii) exposing the complex to excitation light;
(iii) detecting fluorescence emitted by the complex.

10. The reagent according to claim 2, wherein the ionic liquid is at least one selected from the group consisting of 1-ethyl-3-methylimidazolium acetate, 1-butyl-3-methylimidazolium acetate, 1-ethyl-3-methylimidazolium tetrafluoroborate, 1-butyl-1-methylpyrrolidinium bis(fluorosulfonyl)imide, 1-butylpyridinium bis(trifluoromethanesulfonyl)imide, 1-methyl-1-propylpiperidinium bis(fluorosulfonyl)imide, 1-ethyl-3-methylimidazolium bis(trifluoromethanesulfonyl)imide, and methyl 1-butyl-3-methylimidazolium dicyanamate.

11. The reagent according to claim 2, wherein the terbium compound is terbium carboxylate.

12. The reagent according to claim 2, wherein the weight ratio of the ionic liquid to the terbium compound is 2 to 40 times.

13. A methyl salicylate sensor for detecting methyl salicylate comprising:
a capture section of methyl salicylate having the reagent according to claim 2, and
a detection section detecting that methyl salicylate has been recognized by the capture section.

14. The methyl salicylate sensor according to claim 13, wherein the capture section comprises a medium containing the reagent.

15. The methyl salicylate sensor according to claim 14, wherein the medium is a paper, a glass fiber, a resin, or a water-soluble polymer.

16. A method for sensing methyl salicylate, comprising recognizing methyl salicylate using the reagent according to claim 2 comprising:
(i) reacting a terbium compound with methyl salicylate to form a complex;
(ii) exposing the complex to excitation light;
(iii) detecting fluorescence emitted by the complex.

17. A method for sensing methyl salicylate, comprising recognizing methyl salicylate using the methyl salicylate sensor according to claim 6 comprising:
(i) reacting a terbium compound with methyl salicylate to form a complex;
(ii) exposing the complex to excitation light;
(iii) detecting fluorescence emitted by the complex.
